(19) United States
(12) Patent Application Publication
(10) Pub. No.: US 2014/0272890 A1
(43) Pub. Date: Sep. 18, 2014

(54) CONFERENCING ORGANIZER

(71) Applicants: Christine E. DiBuono, Somerville, MA (US); Patrick M. Sheridan, Somerville, MA (US); Deborah R. Reck, Lexington, MA (US); David L. Meyers, Jamaica Plain, MA (US); Jonathan A. Bower, Wayland, MA (US)

(72) Inventors: Christine E. DiBuono, Somerville, MA (US); Patrick M. Sheridan, Somerville, MA (US); Deborah R. Reck, Lexington, MA (US); David L. Meyers, Jamaica Plain, MA (US); Jonathan A. Bower, Wayland, MA (US)

(73) Assignee: Amplify Education, Inc.

(21) Appl. No.: 13/839,553

(22) Filed: Mar. 15, 2013

(51) Int. Cl. G09B 7/00

(52) U.S. Cl. CPC G09B 7/00
USPC 434/350

(57) ABSTRACT

A conference mode screen is displayed on a computing device. The conference mode screen includes a list of students. A selection of a student from the list of students is received from a user. In response to the selection of the student, a list of action buttons is presented. The action buttons may correspond to actions that can be taken by a teacher during a conference with the selected student. A selection of an action button from the list of action buttons is received. The selected action button corresponds to an action taken by the teacher during the conference with the selected student. An indicator of the action is stored in association with a student identifier for the selected student and a sequence indicator.

### TECHNICAL FIELD

This specification relates to aiding an instructor in capturing aspects of his or her teaching habits.

### BACKGROUND

In certain circumstances, an instructor may wish to record instructional interactions with students and interactions between students.

### SUMMARY

In one aspect, a conference mode screen is displayed on a computing device. The conference mode screen includes a list of students. A selection of a student from the list of students is received from a user. In response to the selection of the student, a list of action buttons is presented. The action buttons may correspond to actions that can be taken by a teacher during a conference with the selected student. A selection of an action button from the list of action buttons is received. The selected action button corresponds to an action taken by the teacher during the conference with the selected student. An indicator of the action is stored in association with a student identifier for the selected student and a sequence indicator.

Implementations can include one or more of the following features. For example, the conference may be conducted in-person while the student is engaged in a writing assignment. The sequence indicator may be a date corresponding to when the conference took place. The actions may be aligned with a specific pedagogy for teaching a particular subject to students. The subject may be English Language Arts.

A record that indicates actions taken by the teacher during prior conferences with the selected student may be accessed. In response to the selection of the selected student and based on the accessed record, a history of actions may be presented. The history may indicate actions taken by the teacher in prior conferences with the selected student and a sequence of the actions taken. The accessed record may include one or more comments entered by the teacher during one or more of the prior conferences. The comments may be displayed in the history of actions.

A list of observation buttons may be presented. The observation buttons may correspond to observations that the teacher may make of a student's work without conducting a conference. A selection of an observation button from the list of observation buttons may be received. The selected observation button may correspond to an observation made by the teacher of the selected student's work. An indicator of the observation may be stored in association with a student identifier for the selected student and a sequence indicator.

The list of students may include at least one icon next to at least one student in the list of students. The icon may represent a period of time since the user conducted a conference with the at least one student.

A sharing mode screen may be displayed. The sharing mode screen may include the list of students. A selection of a first student from the list of students may be received. The first student may have presented their work to a class. In response to receiving the selection of the first student, a response mode screen including a second list of students may be presented. An indication that the first student has shared may be stored in association with a student identifier for the first student and a sequence indicator for the sharing. A selection of a second student from the second list of students may be received. The second student having responded to the first student's presented work. A list of rating buttons may be presented. The rating buttons may correspond to ratings that the teacher may use to rate the second student's response. A selection of a rating button may be selected from the list of rating buttons. The selected rating button may correspond to a rating given by the teacher to the second student's response. An indicator of the rating may be stored. The rating may be stored in association with a student identifier for the second student and a sequence indicator for the rating. In response to receiving the selection of the first student, a confirmation button may be presented. A selection of the confirmation button may be received. Presenting the response mode screen may be performed in response to receiving the selection of the confirmation button. A relationship between the first student, as sharer, and the second student, as responder, may be stored in association with the indication that the first student has shared.

An alert may be generated based, at least in part, on a plurality of stored indicators of selected actions. The stored indicators of selected actions may correspond to actions taken by the teacher during conferences with the students. A report may be generated based, at least in part, on a plurality of stored indicators of selected actions, the stored indicators of selected actions corresponding to actions taken by the teacher during conferences with the students. In another aspect, a conference mode screen is displayed on a computing device. The conference mode screen includes a list of students. A selection of a student from the list of students is received from a user. In response to the selection of the student, a list of action buttons is presented. The action buttons correspond to actions that can be taken by a teacher during a conference with the selected student. The actions are aligned with a specific pedagogy for teaching writing, and the conference is conducted in-person while the student is engaged in a writing assignment. A selection of an action button from the list of action buttons is received. The selected action button corresponds to an action taken by the teacher during the conference with the selected student. The action is stored in association with a student identifier for the selected student and a sequence indicator.

The details of one or more implementation of the subject matter described in this specification are set forth in the accompanying drawings and the description below. Other potential features, aspects, and advantages of the subject matter will become apparent from the description, the drawings, and the claims.

### DESCRIPTION OF DRAWINGS

FIG. 1 is a diagram showing an example of an environment in which an application to record teaching habits may be employed.

FIG. 2 is a flowchart showing an example of a process for a conference mode of a CSO application.

FIG. 3 is a flowchart showing an example of a process for a sharing and response mode of a CSO application.

FIG. 4 is a series of illustrations showing examples of conference mode screen screenshots.

FIG. 5A is an illustration showing an example of a sharing mode screen screenshot.

FIG. 5B is an illustration showing an example of a response mode screen screenshot.

FIGS. 6A-6D are a series of illustrations showing examples of an alert screenshot and report screenshots.

Like reference symbols in the various drawings indicate like elements.

### DETAILED DESCRIPTION

FIG. 1 is a diagram 100 showing an example of an environment in which an application to record teaching habits may be employed. FIG. 1 also illustrates an example class flow for which the application may be employed during states (a) to (c). Briefly, the diagram 100 includes a teacher 102 using the application on a computing device 104 and students 106a-106d. For example, the application may be used to record various interactions between the teacher 102 and an individual student 106a, between two or more students 106a-106d, or between the teacher 102 and the class 106a-106d. After class, for instance, the teacher 102 may review the stored data to plan future classes or evaluate her students' 106a-106d progress. The application also may be used to guide a teacher 102 while implementing a specific pedagogy for teaching a subject, for example.

In more detail, the diagram 100 includes computing device 104 operating a Conference and Sharing Organizer (CSO) application. The CSO application may be a web-based application or installed on computing device 104. Using a series of displays (e.g. 108, 110, and 112), the CSO application may help guide the teacher 102 through a certain pedagogical class flow while capturing and organizing events during the class. In general, the following description uses the example of an English Language Arts teacher 102 teaching a writing class. The CSO application, however, may be useful for teaching a variety of other courses, for example, foreign language classes, science lab-based classes, or other similar classes.

Computing device 104 may be, for example, a tablet computer, a smartphone, or a laptop computer. The computing device 104 may have a touch screen display and network access, such as wireless internet access (e.g. Wi-Fi or 4G access). The CSO application may be accessed either using the computing device's 104 network access in a web-based implementation or directly from the computing device's 104 internal memory in the case of an installed implementation. In either event, a processor of the computing device implements the CSO application. A teacher 102 may use the CSO application to record and organize a series of interactions with and between students 106a-106d during a class, for example. In addition, the CSO application may guide the teacher 102 through an example class work flow including of a conference stage, a sharing stage, and a response stage. Moreover, in some implementations, the CSO application may provide alerts to the teacher 102, informing the teacher 102 of student and course progress, for example. Before and after class, the teacher 102 may use report features, included in implementations of the CSO application to review student progress and prepare for future classes, for instance.

A CSO application implemented on a computing device 104 may allow teachers to more efficiently organize their class time, capture a class flow, document interactions with students, and remind teachers to use specific teaching techniques. Such advantages may be beneficial to middle school English Language Arts teachers, for example. A middle school class may range in size from 20 to 35 students. Moreover, a teacher may teach up to 5 or 6 separate groups of students per day or week. Many classes may even have more than one teacher in the room on some days. For example, there might be a student teacher, a special education teacher, or an aide, all of whom have some responsibility for the students. The CSO application can provide a mechanism for capturing class flow data in such a manner that multiple teachers who teach a particular class may be aware of the class flow history and efficiently plan for future classes. Even more, when aligned with a specific pedagogy for teaching a subject, the CSO application will also help to maintain a consistent teaching pattern or method for students, while perhaps even training newer teachers and reminding experienced teachers of teaching strategies and methods that they can apply.

The process illustrated in FIG. 1 shows a more particular example of a standard class flow for a writing class using the CSO application. In this example, the students 106a-106d are engaged in a writing exercise, for example, journal writing, personal narratives, writing in response to a text, or fictional writing. During a conference stage, the teacher 102 may engage a few students 106a in an over the shoulder conference (OTSC) during the writing assignment. At this state, the teacher 102 uses display 108 to track students with whom she has engaged in conferences and the feedback she has provided to each. During a sharing stage, the teacher 102 may ask one or more students 106a to share a portion of their work with the class. The CSO application may help the teacher track which students have shared and when (display 110). Next, during a response stage, several students 106c may be asked to respond to a classmate's 106a writing. The teacher 102 may use the CSO application (display 112) to track the quality of student responses.

In more detail, during state (a), the students 106a-106d are engaged in a writing assignment. During the writing assignment, for example, a specific pedagogy may require a teacher 102 to engage in brief conferences with students to critique their writing and provide suggestions for improvement. Such conferences may be considered over the shoulder conferences (OTSC) with the students because they occur at the student's desk while the student is working on an assignment. The CSO application aids the teacher in implementing such a pedagogy and tracking any feedback the teacher 102 provides to specific students 106a-106d. For example, a screen such as 108 may be presented in the CSO application during the OTSCs. The CSO application may present a list of the students 106a-106d who are enrolled in a particular class taught by the teacher 102. In some implementations, the list may be viewed alphabetically by student names or sorted based on the elapsed time since the last OTSC with each student. Such implementations may allow a teacher 102 to easily rotate through performing OTSCs with every student on a regular basis and may encourage a teacher to give attention to those students most in need. When a teacher 102 engages a particular student 106a in an OTSC to discuss the student's assignment, the CSO application may allow the teacher 102 to select that student's name, for example, by touching the student's name on the computing device's 104 touch sensitive display.

In response to receiving the selection of a particular student 106a, the CSO application may display a list of buttons corresponding to actions that can be taken by the teacher 102 during the OTSC with the student 106a. In some implementations, the actions displayed correspond to suggested instructions or feedback that the teacher 102 might provide to the student 106a for the student 106a to improve his or her writing. In some implementations, the actions align with a specific pedagogy for teaching a subject, for example. Such implementations may help guide the teacher 102 in implementing the specific pedagogy.

Once the teacher 102 selects a specific action to take during the OTSC, the teacher 102 may select the applicable action button displayed on the computing device 104. For example, the teacher 102 may say to the student 106a, “I like how you described scoring the winning run in your baseball game,” and then select an appropriate action button corresponding to this comment. The CSO application may then store an indicator of the selected action in association with student identifier for the selected student 106a and a sequence indicator, for example, a date. The stored data may be used by the CSO application to generate reports and alerts.

During state (b), the teacher 102 selects a student 106a to share his or her work with the class, for example the student 106a's story about what the student did over his or her summer vacation. This may be considered a sharing stage of the class flow. During this sharing portion of the class, the teacher 102 may employ a CSO application sharing mode screen 110. The display 110 may present a similar list of students to the teacher as that presented in conference mode (display 108). Similarly, some implementations may allow the teacher 102 to alternate between lists sorted alphabetically or by the amount of time elapsed since each last shared their work.

Once the teacher 102 chooses a student 106a to share his or her work, the teacher may select that particular student's name from the list of names displayed on the computing device 104. Upon receiving the selection the CSO application may store an indication that the student has shared his or her work in association with the student's identifier and a sequence indicator. Additionally, the CSO application may transition to a response mode screen 112, in some implementations. In addition, some implementations of the CSO application may present a confirmation button upon receiving the selection of a sharing student prior to storing the sharing indication and transitioning to the response mode display 112, for example a “Begin Sharing” button.

During state (c), the teacher 102 selects one or more students 106c to respond to the first student 106a's shared work. The teacher may ask the second student 106c, for example, what writing styles, techniques, words, phrases, diction, or writing structures the first student 106a used well to describe his or her summer vacation. As above, the teacher may select the second student from a list of students displayed on the response mode screen 112 on the computing device 104. The response mode screen list also may be sorted alphabetically or by time since each student has responded to another student's work, for example. In addition, the CSO application may present a list of rating buttons corresponding to ratings or evaluations that the teacher 102 may give to the responding student 106c's responses. For example, if the student provides a vague response such as, “It sounds like fun,” then the teacher 102 may prompt the student 106c for a more precise critique and select an appropriate rating button corresponding to the student's response.

Upon receiving a rating button selection, the CSO application on computing device 104 may store an indicator of the selected rating in association with the second student's identifier and a sequence indicator. Some implementations, may also store a relationship between the sharing student and the responding student in association with the student identities of each student and a sequence indicator; thereby allowing a teacher to ensure each student receives a critique from every other student over a period of time, for example, during a semester.

FIG. 2 is a flowchart showing an example of a process 200 for a conference mode of a CSO application. Briefly the process 200 includes displaying, on a computing device, a conference mode screen, the conference mode screen including a list of students, receiving, from a user, a selection of a student from the list of students, presenting, in response to the selection of the student, a list of action buttons, the action buttons corresponding to actions that can be taken by a teacher during a conference with the selected student, receiving a selection of an action button from the list of action buttons, the selected action button corresponding to an action taken by the teacher during the conference with the selected student, and storing an indicator of the action in association with an identity of the selected student and a sequence indicator.

In more detail when process 200 begins, a conference mode screen, including a list of students, is displayed on a computing device (210). The list of the students may be a list of students who are enrolled in a particular class with the teacher, for example. In some implementations, the list may be viewed alphabetically by student names or sorted based on the elapsed time since a previous conference with each specific student. Another implementation may allow a user to toggle between either sorting method. A list sorted by time since a previous conference may contain, for example, two or more sub-lists or blocks of students and each sub-list may indicate the number of classes that have passed since the previous conference. For instance, sub-lists may include students with whom the teacher performed a conference today, last class, two classes ago, etc. Alternatively, the time frames may be listed by date instead of by the number of classes that have passed since a prior conference.

The computing device receives a selection of one student from the list of students (220). The computing device may receive the selection, for example, by a touch on a touch sensitive display, by a mouse click, or via a touch pad. The computing device, then, presents a list of action buttons corresponding to actions that can be taken by a teacher during a conference with the selected student on a display (230). In some implementations, the actions align with a specific pedagogy for teaching a specific subject, for example they may correspond to suggestions or instructions that a teacher can or should provide to students to improve their writing. For example, action buttons may include prompts to teachers such as “I like how you . . . ”, “Remember to use . . . ”, “Add two sentences . . . ”, or “Are you stuck?”

Some implementations may also include a set of observation buttons. The observations buttons may be used by a teacher after the teacher has observed a student's work and decides that a conference is not necessary, but would like to record the student's progress that she observed. For instance, a teacher may observe a student with the intention of performing a conference but discover from the observation that the student is performing well. Even though the teacher did not perform a conference, the teacher may wish to record the observation to track the specific student's progress. For example, observation buttons may include observations such as “Using skills and habits,” “Working hard,” “More pressing needs,” or “I'm stumped.” Thus the observation buttons may indicate that a student's progress is positive, negative, or neutral. In addition, the observation buttons may also align with a specific pedagogy for teaching a subject.

The computing device receives a selection of the action button corresponding to an action taken by the teacher during the conference with the selected student (240) and stores an indicator of the selected action in association with a student identifier and a sequence indicator (250). A student identifier may be, for example, the student's first and last name, their initials, a student ID number, etc. The sequence indicator may be, for example, a date, a timestamp, a class number, or a sequencing number that indicates when the selected action occurred. Some implementations, may allow the teacher to select several ratings for a given second student based on multiple actions taken by the teacher during a particular conference.

FIG. 3 is a flowchart showing an example of a process 300 for sharing and response mode of a CSO application. Briefly the process 300 includes displaying a sharing mode screen, the sharing mode screen including the list of students, receiving a selection of a first student from the list of students, the first student having presented their work to a class, presenting, in response to receiving the selection of the first student, a response mode screen including a second list of students, storing an indication that the first student has shared in association with an identity of the first student and a sequence indicator for the sharing, receiving a selection of a second student from the second list of students, the second student having responded to the first student's presented work, presenting a list of rating buttons, the rating buttons corresponding to ratings that the teacher may use to rate the second student's response, receiving a selection of a rating button indicating from the list of rating buttons, the selected rating button corresponding to a rating given by the teacher to the second student's response, and storing an indicator of the selected rating, the indicator of the selected rating being stored in association with the identity of the second student and a sequence indicator for the rating.

In more detail when process 300 begins, a sharing mode screen, including a list of students, is displayed on a computing device (310). As described above, the list of the students may be a list of students who are enrolled in a particular class taught by the teacher, for example. Additionally, implementations may present the list alphabetically by student names, sorted based on the elapsed time since each student previously shared his or her work with the class, or allow a user to toggle between either sorting method. As with the conference mode display, a list sorted by time since each student has shared may contain two or more sub-lists or blocks of students and each sub-list may indicate the number of classes that have passed since the students in each sub-list shared their work. For instance, sub-lists may include students who shared their work with the class today, last class, two classes ago, etc. Alternatively, the time frames may be listed by date instead of by the number of classes that have passed.

The computing device, then, receives a selection of a first student who will present their work in class (320). The computing device may receive the selection, for example, by a touch on a touch sensitive display, by a mouse click, or via a touch pad. In some implementations, a confirmation button may be presented in response to a first student being selected. For example, a “Start Sharing” button may be presented and a user may be required to select the confirmation button before the application will proceed to a response mode screen and store any sharing related data.

The computing device presents a response mode screen including the list of students (330). As with the student lists described above, the list of the students may be a list of students who are enrolled in a particular class with the teacher, for example. Additionally, several implementations may present the list alphabetically by student names, sorted based on the elapsed time since each student previously responded to a classmate's shared work, or allow a user to toggle between either sorting method. As with the conference and sharing mode displays, a list sorted by time since each student has responded may contain two or more sub-lists or blocks of students and each sub-list may indicate the number of classes that have passed since the students in each sub-list responded to a classmate's work. For instance, sub-lists may include students who responded to a classmate's work today, last class, two classes ago, etc. Alternatively, the time frames may be listed by date instead of by the number of classes that have passed. In some implementations the student list or sub-lists in the response mode screen do not include the student who was selected in step (320) to share. For example, if a teacher selected Rae Luo to share her writing with the class her name would not be included in a student list or a sub-list on the response mode screen.

The computing device stores an indication that the first student shared in association with the first student's identifier and a sequence indicator (340). A student identifier may be, for example, the student's first and last name, their initials, a student ID number, etc. The sequence indicator may be, for example, a date, a timestamp, a class number, or a sequencing number that indicates when the selected student shared his or her work.

The computing device receives a selection of a second student who will respond to the first student's presented work (350). The computing device may receive the selection, for example, by a touch on a touch sensitive display, by a mouse click, or via a touch pad. The computing device, then, presents a list of buttons displaying possible ratings for the second student's response (360). In some implementations, the ratings align with a specific pedagogy for teaching a specific subject, for example they may correspond to suggested ratings that a teacher can or should provide to students for teaching the student to provide specific and helpful feedback to classmates. For example, actions buttons may include prompts to teachers such as “Precise and targeted”, “Less vague with prompt”, or “Vague despite prompt.”

The computing device receives a selection of the button indicating a rating for the second student's response (370) and stores an indicator of the selected rating in association with the second student's identifier and a sequence indicator (380). A student identifier may be, for example, the student's first and last name, their initials, a student ID number, etc. The sequencing indicator may be, for example, a date, a timestamp, a class number, or a sequencing number that indicates when the rated response occurred. In some implementations, a relationship between the sharing student, as sharer, and the responding student, as responder, may also be stored in association with the student identities of each student and a sequence indicator; thereby allowing a teacher to ensure each student receives a critique from every other student over a period of time, for example during a semester.

In some implementations, actions (330)-(380) may be repeated if multiple students are called on to respond to the first student. For example, a teacher may ask two or three students to respond to the first student's presentation of his or her work. In some implementations, a menu bar may be presented on each screen allowing a user to alternate between conference, sharing, and response mode screens.

Some implementations may include a list of share rating buttons corresponding to ratings that a teacher may use to evaluate the quality of a sharing student's presentation to the class. As with the action and rating buttons, the sharing buttons may align with a specific pedagogy for teaching a subject. A teacher may use them in a manner similar to that described for the response rating buttons above in step (360). In such implementations, an indication of the selected share rating button would be stored in association with the first student's identifier and a sequence indicator that indicates when the rated student presentation occurred.

In some implementations, any or all of the modes described above may include an area to allow a user to enter a comment or note associated with the conference, shared presentation, or rated response. The comment may be stored in association with the respective conference action, sharing indication, or response rating. In some implementations the comment may be deleted when the subsequent conference action, sharing indication, or response rating is entered for a specific student. In other words, a comment may only be stored until a subsequent conference action, sharing indication, or response rating is entered for a specific student.

The processes 200 and 300 may be implemented in either an application installed on a computing device or as a web-based application. In either implementation data may be stored either locally (e.g. on the computing device) or remotely (e.g. on a network server). In a web-based implementation, the application may be configured to remain active on the computing device when a network connection fails. For example, if a Wi-Fi connection is lost such an implementation may allow a teacher to continue using the application in an offline mode and provide warnings that data will not be saved if the teacher closes the application before reconnecting to the internet. In addition, a web-based implementation may be accessible by any internet enabled computing device, for example, using a username and password, such that a teacher can access the CSO application from multiple computing devices.

FIG. 4 is a series of illustrations showing examples of conference mode screenshots 400 and 450. Screenshot 400 illustrates a conference mode screen including a list of students 402 sorted by time since their last conference. In addition, the illustrated example shows a selection bar 404 for allowing a user to toggle between an alphabetical student list and the presented list, sorted by prior conference date. In some implementations the displayed list of students may include icons 406 or flags 408 next to a student's name. The icons 406 may be toggled on and off by a user and may represent students with whom the teacher plans to perform a conference, for example. Flags 408 may be added or removed by a user as a general reminder to follow up with a specific student or other similar reminders, for example. The icons 406 and flags 408 may be useful for class preparation.

Screenshot 400 also illustrates a list of action buttons 410 and a list of observation buttons 412. As described above, the action buttons and observation buttons may be used both to guide a teacher in implementing a specific pedagogy and to record instructions provided to students during a conference and observations made by a teacher while observing the selected student perform his or her work. In some implementations, comment section 414 may be provided allowing a teacher to add a text note describing the conference. For example, comment 414 includes an “edit” button to allow the user to change the comment.

Screenshot 450 illustrates a conference mode screen including a list of students 452 sorted alphabetically by name. Icons 454 indicating the number of classes which have passed since the last conference with each student may be displayed next to each name in the alphabetical student list 452, in some implementations. For example, icon 454 indicates that it has been more than three classes since the teacher has performed a conference with Rae Lattin. Furthermore, the selected student's name may be displayed 456 as a confirmation that the student has been selected. For example, in screenshot 450 Cody Toews has been selected for a conference so his name is displayed 456 in the upper right corner confirming that he has been selected.

In addition, the action 410 and observation buttons 412 may be displayed in a scroll bar, which when scrolled reveals a conference history 458 for the selected student. The conference history 458 may include one or more entries each displaying an action that the teacher took during a prior conference with the selected student and the date of the prior conference, for example. Conference history 458 entries may be generated, for example, by accessing a record of stored action indicators describing actions taken by the teacher during one or more prior conferences with the selected student. In some implementations, a teacher comment that was stored in association with each prior conference may also be displayed in the entries.

In some implementations, the display may also include a menu bar 460 that allows the user to toggle between conference mode, sharing mode, and response mode screens. Additionally, the menu bar 460 may include a class or period drop down list 462 that allows a teacher to cycle between each of the classes taught by the teacher. In addition, some implementation may display a resettable timer (not shown) which would allow the teacher to easily track the time remaining for students to complete in-class assignments and for the teacher to complete over the shoulder conferences. Some implementations may also allow a user to toggle between mode screens by using touch screen gestures such as swiping, for example.

FIG. 5A is an illustration showing an example of a sharing mode screen, screenshot 500. Screenshot 500 illustrates a sharing mode screen including a list of students 502 sorted by time since their last conference. The list of students 502 may include sharing icons 504 which may be toggled on or off for each student by a teacher to indicate that a teacher plans to ask a particular student to share. For example, a teacher may toggle on sharing icon 504 next to Jamie Schmieder's name while preparing for class as a reminder to call on Jamie to share her assignment with the class. Screenshot 500 also illustrates an implementation including a confirmation button 506 requiring a user to confirm the student selected to share. In some implementations, selecting the confirmation button may start a preset timer (not shown).

The sharing screen also may include an area for entering comments or notes 508 similar to that of the conference mode screen. In addition, the sharing screen may include a sharing history 510 organized similarly to the conference history 458 described above in reference to FIG. 4.

FIG. 5B is an illustration showing an example of a response mode screen screenshot 550. Screenshot 550 illustrates a response mode screen including a list of students 552 sorted by time since their last conference. Screenshot 500 also illustrates a list of rating buttons 554. As described above the rating buttons may be used both to guide a teacher in implementing a specific pedagogy and to record the teacher's evaluation of the selected student's responses to his or her classmate's presented work. The response screen also may include an area for entering comments or notes 556 similar to that of the conference mode screen. In addition, the response screen may include a response history 558 organized similarly to the conference history 458 described above in reference to FIG. 4.

FIGS. 6A-6D are a series of illustrations showing examples of an alert screenshot 600 and report screenshots 620, 640 and 650. The computing device may use the conference, sharing, and response data stored by a user to generate alerts and reports. For example, the computing device may generate an alert or report related to conferences based on a plurality of stored action indicators describing actions taken by the teacher during a plurality of prior conferences. Alerts and reports pertaining to the sharing and responding portions of the class flow also may be generated using stored sharing indications and rating indicators.

FIG. 6A illustrates an example screenshot of an alert screen. Alerts may be presented to a user when the computing device or the CSO application is started using an alert screen as illustrated in example screenshot 600. The alert screen 600 shows a list of alerts 602. The alerts 602 may include a brief description of the alert, a date corresponding to when the alert was generated, and an indication 604 of the class to which the alert pertains. In some implementations, alerts may be presented as popup boxes.

As with the conference and response mode buttons, alerts may be aligned with a specific pedagogy for teaching a particular subject. For example, if a specific pedagogy suggests that a teacher should perform nine conferences during each writing session then an alert may be generated if the teacher's average number of conferences preformed deviates from this standard. Thus, alerts may be used to keep a teacher apprised of his or her teaching habits as compared to a specific pedagogy. Alerts may also be used to keep a teacher informed about other data trends such as, for example, student progress. Furthermore, because teachers' schedules are often busy, alerts also may be used to prompt teachers to review data reports on a regular basis. Below is a list of some examples of alerts that may be used in some implementations:
a) Average number of OTSCs per week
b) Students who have not had an OTSC in a specified number of sessions
c) Heavy use of a particular conference action
d) Students who have not shared in a specified number of sessions
e) Inconsistent use of conferences, sharing, or student responses
f) No conferences, sharing, or responses performed within a specified period of time
g) Students who have not responded in a specified number of sessions
h) Average number of responses per sharer
i) Highlight student or class progress.

Alerts may be either conditional or reoccurring. Moreover, conditional alerts may inform a user about a goal that has been reached, about a failure to meet a standard, or about data trends. A conditional alert informing a user that a goal has been reached may be, for example, “Twenty-percent more student responses are ‘Precise and Targeted.’” Alternatively, a conditional alert informing a user about a failure to meet a standard may be “No sharing in three weeks,” for example. Also, a conditional alert informing a user about data trends may be “Heavy use of ‘Add two sentences,’” for instance. Whereas, a reoccurring alert may be “Averaged 9 OTSCs this week,” for example.

In some implementations, a user may select an alert 602 to view a report that is associated with the selected alert. FIGS. 6B-6D illustrate a series of example screenshots of report screens which may be presented in response to a user selecting a displayed alert. In some implementations, report screens may also be accessible via selection menus. Each of the report screens illustrated in FIGS. 6B-6D will have many features in common, which will only be described in reference to FIG. 6B, however, it will be apparent that the features are applicable to each example illustrated.

FIG. 6B illustrates an example of a screenshot of a conference summary report screen 620. In general, the report screen 620 illustrates a bar graph 622 representing actions performed by a teacher during OTSCs, several data manipulation menus 626, 628 menus, and data labels 630, 632, 634. For example, the conference summary report 620 illustrates how often a teacher used each of the available action buttons during conferences for a given week. In some implementations, a text box 624 presenting details of the specific data may be displayed when a user either selects or hovers over a portion of the data. For example, when a user selects a section of the bar graph 622 a text box is displayed listing each of the students to whom the teacher advised “Add two sentences . . . ” last Friday.

In some implementations, a user may be permitted to modify the presented data. For example, the report screen 620 illustrates two data selection menus; one for selecting the timeframe represented in the report 626 and one for selecting the scope of data presented in the report 628. The timeframe drop-down menu 626 may adjust the values on the x-axis, to expand or contract the displayed timeframe, for example. Whereas, the data scope drop-down menu 628 may be used to filter which data is used to generate the report. For example, the report may be generated using data for all students in a given class or filtered, using drop-down menu 628, to display data associated with only a sub-set of all the students.

Report screens such as screen 620 may also include descriptions of additional information related to the data presented. For example, the conference report screen includes an indication of which class's data is represented 630 (e.g. “Class 1”), an optimum or expected range 632 for the displayed data, and an indication of an alert 634 associated with the report. In some implementations, the optimum or expected range may be aligned with standards related to a specific pedagogy, for example, a teacher may be expected to complete 8-12 OTSCs during each writing session.

FIG. 6C illustrates an example screenshot of an alternative format for a report screen 640, in this case a response summary report screen. Report screen 640 illustrates a pie graph 642 of data representing the number of class sessions since students in the class provided a response to a classmate's work. For example, each slice of the pie represents the number of students who have not responded within a given number of class sessions. In addition, report screen 640 illustrates an example key 644 indicating the time period represented by each slice. The key 644 also may provide a list of the students represented by each slice of the pie in some implementations. For example, in report 640 Earl and Andrew have not responded for two class sessions. Put differently, Earl and Andrew last responded three class sessions ago. As shown in report 620, report 640 also includes an indication of an alert 646 that may be associated with the report 640, for example, “Number of Sessions Students have gone without Responding.”

FIG. 6D illustrates an example screenshot of an expanded view for a report screen 650, again an example response summary report screen. Report screen 650 illustrates a bar graph 652 of data representing the number a teacher used each rating during a series of class sessions spanning three weeks, as indicated by time frame drop-down menu 654. Also illustrated on the response bar graph, is an optimum or expected range of responses 656, which, as with similar range illustrated in FIG. 6B, may indicate the number of responses a teacher should expect from students when implementing a specific pedagogy. For example, a teacher may be expected to call on 1-5 different students to respond per class session. As shown in reports 620 and 640, report 650 also includes an indication of an alert 658 that may be associated with the report 640, for example, “20% More Students are ‘Precise and Targeted.’”

The techniques described herein can be implemented in digital electronic circuitry, or in computer hardware, firmware, software, or in combinations of them. The techniques can be implemented as a computer program product, i.e., a computer program tangibly embodied in an information carrier, e.g., in a machine-readable storage device, in machine-readable storage medium, in a computer-readable storage device or, in computer-readable storage medium for execution by, or to control the operation of, data processing apparatus, e.g., a programmable processor, a computer, or multiple computers. A computer program can be written in any form of programming language, including compiled or interpreted languages, and it can be deployed in any form, including as a stand-alone program or as a module, component, subroutine, or other unit suitable for use in a computing environment. A computer program can be deployed to be executed on one computer or on multiple computers at one site or distributed across multiple sites and interconnected by a communication network.

Method steps of the techniques can be performed by one or more programmable processors executing a computer program to perform functions of the techniques by operating on input data and generating output. Method steps can also be performed by, and apparatus of the techniques can be implemented as, special purpose logic circuitry, e.g., an FPGA (field programmable gate array) or an ASIC (application-specific integrated circuit).

Processors suitable for the execution of a computer program include, by way of example, both general and special purpose microprocessors, and any one or more processors of any kind of digital computer. Generally, a processor will receive instructions and data from a read-only memory or a random access memory or both. The essential elements of a computer are a processor for executing instructions and one or more memory devices for storing instructions and data. Generally, a computer will also include, or be operatively coupled to receive data from or transfer data to, or both, one or more mass storage devices for storing data, such as, magnetic, magneto-optical disks, or optical disks. Information carriers suitable for embodying computer program instructions and data include all forms of non-volatile memory, including by way of example semiconductor memory devices, such as, EPROM, EEPROM, and flash memory devices; magnetic disks, such as, internal hard disks or removable disks; magneto-optical disks; and CD-ROM and DVD-ROM disks. The processor and the memory can be supplemented by, or incorporated in special purpose logic circuitry.

A number of implementations of the techniques have been described. Nevertheless, it will be understood that various modifications may be made. For example, useful results still could be achieved if steps of the disclosed techniques were performed in a different order and/or if components in the disclosed systems were combined in a different manner and/or replaced or supplemented by other components. Accordingly, other implementations are within the scope of the following claims.

What is claimed is:

1. A method comprising:
displaying, on a computing device, a conference mode screen, the conference mode screen including a list of students;
receiving, from a user, a selection of a student from the list of students;
presenting, in response to the selection of the student, a list of action buttons, the action buttons corresponding to actions that can be taken by a teacher during a conference with the selected student;
receiving a selection of an action button from the list of action buttons, the selected action button corresponding to an action taken by the teacher during the conference with the selected student; and
storing an indicator of the action in association with a student identifier for the selected student and a sequence indicator.

2. The method of claim 1, wherein the conference is conducted in-person while the student is engaged in a writing assignment.

3. The method of claim 1, wherein the sequence indicator is a date corresponding to when the conference took place.

4. The method of claim 1 wherein the actions are aligned with a specific pedagogy for teaching a particular subject to students.

5. The method of claim 4 wherein the subject is English Language Arts.

6. The method of claim 1, further comprising:
accessing a record that indicates actions taken by the teacher during prior conferences with the selected student; and
presenting, in response to the selection of the selected student and based on the accessed record, a history of actions, the history indicating actions taken by the teacher in prior conferences with the selected student and a sequence of the actions taken.

7. The method of claim 6 wherein the accessed record includes one or more comments entered by the teacher during one or more of the prior conferences, the method further comprising displaying the comments in the history of actions.

8. The method of claim 1, further comprising:
presenting a list of observation buttons, the observation buttons corresponding to observations that the teacher may make of a student's work without conducting a conference;
receiving a selection of an observation button from the list of observation buttons, the selected observation button corresponding to an observation made by the teacher of the selected student's work; and
storing an indicator of the observation in association with a student identifier for the selected student and a sequence indicator.

9. The method of claim 1 wherein the list of students includes at least one icon next to at least one student in the list of students, the icon representing a period of time since the user conducted a conference with the at least one student.

10. The method of claim 1, further comprising:
displaying a sharing mode screen, the sharing mode screen including the list of students;
receiving a selection of a first student from the list of students, the first student having presented their work to a class;
presenting, in response to receiving the selection of the first student, a response mode screen including a second list of students;
storing an indication that the first student has shared in association with a student identifier for the first student and a sequence indicator for the sharing;
receiving a selection of a second student from the second list of students, the second student having responded to the first student's presented work;
presenting a list of rating buttons, the rating buttons corresponding to ratings that the teacher may use to rate the second student's response;
receiving a selection of a rating button indicating from the list of rating buttons, the selected rating button corresponding to a rating given by the teacher to the second student's response; and
storing an indicator of the rating, the rating being stored in association with a student identifier for the second student and a sequence indicator for the rating.

11. The method of claim 10, further comprising:
presenting, in response to receiving the selection of the first student, a confirmation button; and
receiving a selection of the confirmation button; and
wherein presenting the response mode screen is performed in response to receiving the selection of the confirmation button.

12. The method of claim 10, further comprising storing a relationship between the first student, as sharer, and the second student, as responder, in association with the indication that the first student has shared.

13. The method of claim 1, further comprising generating an alert based, at least in part, on a plurality of stored indicators of selected actions, the stored indicators of selected actions corresponding to actions taken by the teacher during conferences with the students.

14. The method of claim 1, further comprising generating a report based, at least in part, on a plurality of stored indicators of selected actions, the stored indicators of selected actions corresponding to actions taken by the teacher during conferences with the students.

15. A method comprising:
displaying, on a computing device, a conference mode screen, the conference mode screen including a list of students;
receiving, from a user, a selection of a student from the list of students;
presenting, in response to the selection of the student, a list of action buttons, the action buttons corresponding to actions that can be taken by a teacher during a conference with the selected student, the actions being aligned with a specific pedagogy for teaching writing, and the conference being conducted in-person while the student is engaged in a writing assignment;
receiving a selection of an action button from the list of action buttons, the selected action button corresponding to an action taken by the teacher during the conference with the selected student; and
storing the action in association with a student identifier for the selected student and a sequence indicator.

16. A computer-readable medium including instructions, that when executed, cause one or more processing devices to:
display, on a computing device, a conference mode screen, the conference mode screen including a list of students;
receive, from a user, a selection of a student from the list of students;
present, in response to the selection of the student, a list of action buttons, the action buttons corresponding to actions that can be taken by a teacher during a conference with the selected student;
receive a selection of an action button from the list of action buttons, the selected action button corresponding to an action taken by the teacher during the conference with the selected student; and
store an indicator of the action in association with a student identifier for the selected student and a sequence indicator.

17. The computer-readable medium of claim 16, wherein the sequence indicator is a date corresponding to when the conference took place.

18. The computer-readable medium of claim 16, wherein the actions are aligned with a specific pedagogy for teaching a particular subject to students.

19. The computer-readable medium of claim 16, wherein the instructions include instructions that cause the one or more processing devices to:
access a record that indicates actions taken by the teacher during prior conferences with the selected student; and
present, in response to the selection of the selected student and based on the accessed record, a history of actions, the history indicating actions taken by the teacher in prior conferences with the selected student and a sequence of the actions taken.

20. The computer-readable medium of claim 16, wherein the instructions include instructions that cause the one or more processing devices to:
present a list of observation buttons, the observation buttons corresponding to observations that the teacher may make of a student's work without conducting a conference;
receive a selection of an observation button from the list of observation buttons, the selected observation button corresponding to an observation made by the teacher of the selected student's work; and
store an indicator of the observation in association with a student identifier for the selected student and a sequence indicator.
